(19) United States
(12) Patent Application Publication
(10) Pub. No.: US 2012/0239586 A1
(43) Pub. Date: Sep. 20, 2012

(54) SYSTEM AND METHOD FOR FUNDING NONPROFIT ENDEAVORS USING TARGETING

(76) Inventor: Andrew Vincent Peloso, Princeton, NJ (US)

(21) Appl. No.: 13/423,889

(22) Filed: Mar. 19, 2012

Related U.S. Application Data
(60) Provisional application No. 61/454,257, filed on Mar. 18, 2011.

(51) Int. Cl. G06Q 99/00

(52) U.S. Cl. 705/329

(57) ABSTRACT

An economic allotment computing system and method. The system and method may include a first engine programmed to receive, from a plurality of users, user profile information, and to receive an association by each of the plurality of users of a non-profit endeavor with the respective profile information, a second engine programmed to sell to marketers the user profile information of ones of the plurality of users for at least one of targeted marketing, promotions, polling, and surveying, and a third engine programmed to allot at least a portion of proceeds obtained from the sale executed by the second engine to the non-profit associated with the one of the plurality of users undertaking an action indicated by at least one of the targeted marketing, promotions, polling and surveying.

### BACKGROUND OF THE INVENTION

1. Field of the Invention

This invention relates generally to marketing and advertising, and more particularly to a system, method and apparatus for providing the funding of non-profit endeavors using targeting.

2. Description of the Related Art

Typically, well-targeted advertising and marketing will have the biggest impact on consumers, principally because such advertising and marketing is targeted to users having characteristics, such as demographic characteristics, that would indicate interest in the goods or services being advertised or marketed. As such, the goods or services are targeted to users based on, for example, the age, race, job, geographic location, education level, sex, sexual orientation, interests, hobbies or similar information of the user.

Targeted advertising and marketing has become particularly advantageous in the internet age, due in part to the vast number of internet users, many of whom will not have interest in particular types of marketed goods or services due to the widely varying user characteristics of such a broad user population. Thus, marketers and advertisers of various goods and services prefer to narrow the users to whom the goods and services are marketed to those most likely to have an interest in such goods and services, particularly in embodiments wherein the marketer has to pay for each display of a particular advertisement on a particular website, for example.

While making the targeting of advertisements, polls, surveys, and the like more difficult due to the aforementioned widely varying user characteristics of internet users, the internet has nevertheless broadened the scope of entities that can advertise or market, and/or that can gain the benefits of advertising and marketing. For example, it is now common for entities to market a blog on a particular topic in order to increase traffic to that blog, such as to increase support for certain causes-of-interest, such as those causes historically supported by non-profit entities. As such, marketers and advertisers in the Internet age have expanded to include many types of businesses, such as corporations, joint ventures and consortia, as well as brands, individual persons, groups of persons, interest groups, non-profit entities and causes, and the like. Further, the reasons for advertising and marketing have increased in scope in the internet age, such as to include the sale of products or services, the eliciting of information regarding products or services or the development thereof, the driving or re-directing of user traffic, and/or other information that may aid or direct the management of businesses, sales, or causes of interest.

In order to identify users who are to be targeted, polled, surveyed, or the like, advertisers and marketers typically must first obtain data regarding particular users. This data may be supplied by the individual, may be anecdotal, may be based on regional geographic demographic data, may be obtained from “cookies” placed on a user's computer, or the like. However, regardless of how the user characteristics data is obtained, the user typically has no control over the manner in which the data is used and/or provided to marketers and advertisers.

Therefore, the need exists for a system and method that allows marketers and advertisers to match, to a desired degree, desired user characteristics with marketed goods or services, wherein the user has at least partial control over the products or services to which that user's characteristics are matched.

### SUMMARY OF THE INVENTION

The present invention is and includes an economic allotment computing system and method. The system and method may include a first engine programmed to receive, from a plurality of users, user profile information, and to receive an association by each of the plurality of users of a non-profit endeavor with the respective profile information. The system and method may additionally include a second engine programmed to sell to marketers the user profile information of ones of the plurality of users for at least one of targeted marketing, promotions, polling, and surveying. The system and method may additionally include a third engine programmed to allot at least a portion of proceeds obtained from the sale executed by the second engine to the non-profit associated with the one of the plurality of users undertaking an action indicated by at least one of the targeted marketing, promotions, polling and surveying.

Thus, the present invention provides a system and method that allows marketers and advertisers to match, to a desired degree, desired user characteristics with marketed goods or services, wherein the user has at least partial control over the products or services to which that user's characteristics are matched.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and in which:

FIG. 1 is a system block diagram illustrating a system in accordance with the present invention; and

FIG. 2 is a flow diagram illustrating a method in accordance with the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical economic and economic computing systems and methods. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

Those skilled in the pertinent arts will appreciate, in light of the disclosure herein, that the present invention may be implemented in one or more computing systems comprised of one or more computing apparatuses that may be locally connected, remotely connected via one or more computing networks, or that may parallel process in order to implement the functions and steps discussed herein. Such computing apparatuses may include one or more local or networked inputs, one or more processors, and one or more computer readable memories respectively coupled to the processor(s). Each computer readable memory may include therein an array of ordered values and sequences of instructions which, when executed by one of the processors, cause the processor to compute, transform, modify, or otherwise operate upon the data and information discussed hereinthroughout, such as in order to produce the computing outputs and results discussed herein. For example, the array of ordered values may comprise data used by or obtained from a user. The sequence of instructions may include one or more steps consistent with embodiments of the invention, and preferably comprises that which is typically referred to as computer software. In some embodiments, the sequence of instructions may include application of calculations, algorithms, customization, simulation, comparison, remote communications and networking, and the like.

The processor may be embodied in a general purpose desktop or laptop computer, a server, and/or may comprise hardware and/or software associated with inputs. Alternatively, one or more of the computing apparatuses may be at least partially embodied in a handheld device that may be adapted to be electronically and/or wirelessly coupled to one or more other devices.

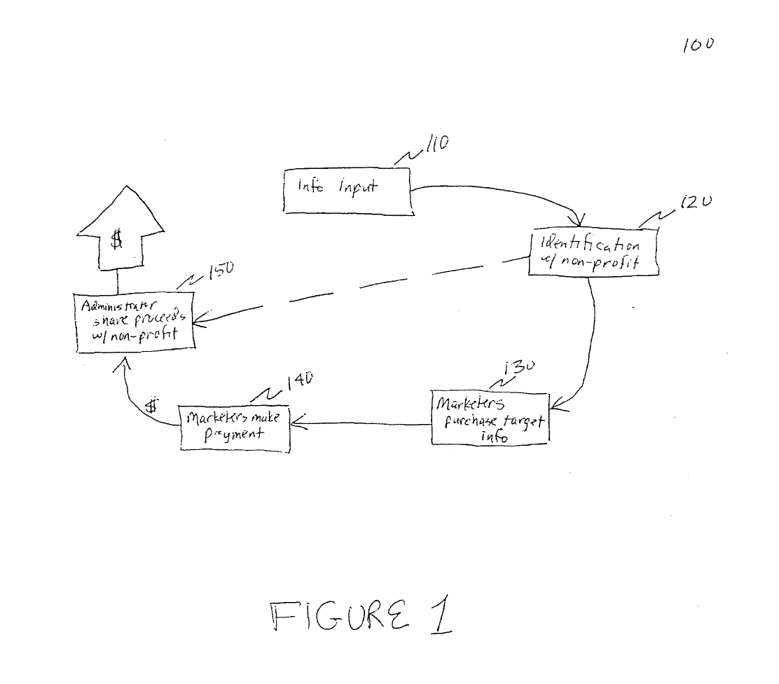

FIG. 1 is a block diagram illustrating a plurality of functional blocks executed in accordance with the system of the present invention. As will be understood by those skilled in the art, the decision blocks illustrated in FIG. 1 may be readily executed by the aforementioned computing processor and computing memory, operating in conjunction with computer executable software code to perform the functions illustrated in FIG. 1.

At system function 110, one or more users may provide personal information to the system 100 of the present invention. Users may provide personal information by, for example, filling out a profile on a site directly associated with the system of the present invention, filling out a profile on an affiliated or participating third party site indirectly associated with the present system 100, by allowing access to a profile entered to a third party site not participating in system 100, by the placement of or monitoring of “cookies’ on the users computer, and/or by like operations known to those skilled in the art. Those skilled in the art will thus appreciate that, in accordance with the present invention, personal information of the user may be entered actively or passively, or partially actively and partially passively, by the user. Also at function 110, the received user information, which may include user characteristics such as age, job, income, geographic location, sex, sexual orientation, interests, or the like, may be indicated to the user as intended for sale to third parties by the recipient administrator, to thereby enable the third party purchaser of the information to perform targeted marketing, promotions, polling, and/or other advertising to the user.

At function 120, subject users may identify themselves, such as via the user's profile, with one or more business endeavors, such as particularly not-for-profit and/or nonprofit endeavors. As such, in preferred embodiments, whether the user information is entered to system 100 passively or actively, the user may receive an indication that the user information has been received, is intended for use in sale to third parties for targeted marketing, and the user may receive a request to enter the desired endeavor, such as the non-profit endeavor, with which that user wishes her information to be associated. For example, a user may be provided with a list of non-profit endeavors from which the user can select, the user may be allowed to enter names of non-profit endeavors which may or may not then be subject to informational searches, such as via Dunn & Bradstreet and/or Google, or multiple users may create groups that are to be associated with non-profit endeavors, wherein such groups or user entered non-profit endeavors may subsequently be added to available non-profit lists upon accessing of system 100 by subsequent users. The recipient administrator of the user information may then preferably store, such as in one or more relational databases associated with the aforementioned computing memory, the user information and an association between the user and the selected not-for-profit endeavor(s).

At function 130, marketers and advertisers may purchase the information of users intended for targeting, promotion, polling, or the like by those marketers and advertisers. More particularly, the marketer may describe a desired set of user information, such as desired demographic criteria, and may agree to pay a price to the recipient administrator of the user information in exchange for the ability to contact, including marketing to, the users that meet some or all of the purchased demographic information. Of course, the purchasing marketer may thereafter target marketing to the users matching the desired demographic criteria, such as wherein the marketing directs the users to a certain location, offers the user a purchase of a particular good or service, asks the user to fill out a survey or poll, or the like, for example.

At function 140, the marketers may pay the recipient administrator of user information based on any agreed-upon factor. For example, the marketer may pay the recipient administrator of the user information based on the ultimate success of the marketing to the users, based on the level of matches of the users to the requested user information from the marketers, or the like. For example, when a user who has shared user information with the recipient administrator responds to an advertisement as desired by the marketer who has agreed to pay the recipient administrator to contact that user, or when the user participates in a promotion of the marketer, the marketer may pay an agreed upon amount to the recipient administrator. Such a user response may include, for example, accessing by the user of a particular link, or purchasing via a click-through of a particular advertisement of a certain good or service.

At function 150, upon receipt of payment from the marketer by the recipient administrator, the recipient administrator may pay an agreed upon portion of the received proceeds to the appropriate non-profit endeavor entered by the user in step 120. Needless to say the paid non-profit is preferably the non-profit entered at step 120 by the particular user who undertook the desired action at step 410.

As such, the present invention provides a system having one or more software apparatuses, or engines, that execute functions 110-150. More particularly, the present invention provides one or more software engines that allow for association by users of the respective user information of each of those users with a non-profit endeavor, that allow for the sale to marketers of that user information for use in targeted marketing, promotions, polling, or the like, and that allow for a payment to the user-directed not-for-profit upon a user action as desired by the purchasing marketer.

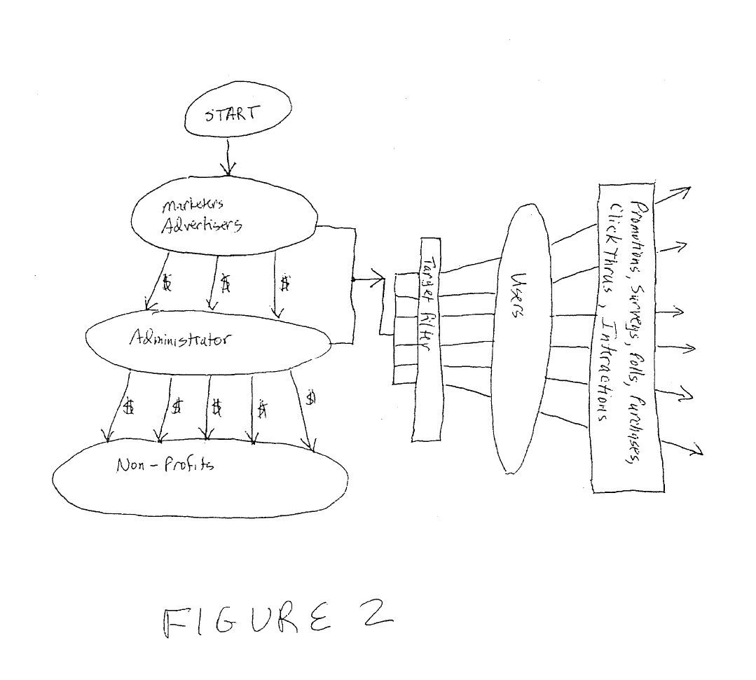

FIG. 2 is a flow diagram illustrating a method that flows proceeds from marketers to a not-for-profit endeavor in accordance with the system 100 of FIG. 1. As illustrated in method 200 of FIG. 2, marketers may pay a third party to push people and/or to allow for targeted marketing to people to undertake a desired user action. At step 220, users may, actively or passively, provide a user profile to the system administrator, thus allowing the administrator to match user profile information to the desired characteristics requested by the marketers at step 210.

At step 230, targeted marketing may occur, such as by requesting user participation in promotions, polls, surveys, purchasing, or any other type of marketer-consumer interaction. Thereafter, at step 250, the administrator that received a payment from the marketers to obtain the desired user actions may share a portion of the proceeds received from the marketers with the non-profit endeavors indicated respectively by each user participating in the desired user action at step 230.

In a more detailed exemplary embodiment of the invention illustrated in FIGS. 1 and 2, a user may make personal demographic information, such as user characteristics, available and accessible to a program administrator to which the user has given implicit or explicit permission to hold the user data associated with that user. As part of the user information held by the administrator, each user may indicate certain non-profit endeavors with which that user wishes to be associated, and thus users may additionally include this information as data available to the administrator.

In exchange for each user making the user information available to the administrator and giving the administrator permission to sell that user's information to third parties, and/or to create and sell products and services to that individual user based on those user characteristics, one or more administrators may agree to pay a portion of any proceeds collected through the use of the user's demographic information to the one or more non-profit endeavors entered by that user into that user's profile. The administrator may, for example, sell the user information to one or more marketers, and such a sale may or may not be made pursuant to a set of parameters agreed to by the user providing the user information, and/or agreed to by the administrator serving as the recipient of the user information.

Once obtained, entities wishing to identify users having user information, such as demographic characteristics, that match, to a particular degree or level, desired user characteristics may input the desired user characteristics into the system and method of FIGS. 1 and 2. Thereafter, the administrator may match the user characteristics of users to the requested user characteristics entered by the requesting entity. This matching may be performed by the administrator manually, or preferably automatically such as through the use of one or more computing systems, and may be performed by the administrator or may be performed by an associate of the administrator. Further, the administrator, or an associate thereof, may determine a price to be associated with particular user information, quantities of user information, targeted use for user information, or the like. For example, the most desirable user information may be age and income level, so a premium charge may be asserted to obtain this particular user information.

If the requesting entity agrees to pay the determined price for access to the user information, an agreement may be made between the administrator and the requesting entity. Such an agreement may be formed electronically, or through the use of paper contracts, for example. The administrator may then indicate to the matched users that the requesting entity wishes to engage the information associated with those users, and may forward instructions to the matched users as to how to engage, or when to expect engagement, with the requesting entity. These instructions may include, for example, that honoring the request to engage with a requesting entity may indicate that the user is affirmatively allowing passage of some or all of the user information to the requesting entity.

As such, the users may engage directly with the requesting entity, or may, at various stages along the process, have allowed for the sale of the user information associated with that user to a requesting entity. Thereafter, if the user successfully engages with the requesting entity, or with a party that has received the user information from the requesting entity, in the manner desired based on the purchase of the user information from the administrator, the predetermined price may be paid by the requesting entity to the administrator. The administrator may then distribute all, or a portion of, the received price among interested parties, such as by directing the allotted portion of the proceeds to the non-profit entity indicated by that user for association with that user's information. Additionally and alternatively, payment may be made directly from the requesting entity to the non-profit entity based on the user's information purchased by the requesting entity.

In alternative embodiments, rather than user information being passed directly to the requesting entity, a user interaction may be purchased by the requesting entity. For example, a user may indicate in a user profile a willingness to participate in particular types of surveys in exchange for the forwarding of proceeds from the surveys to a non-profit entity associated with that user. Thereby, the participation of that user in a particular survey may be purchased from the administrator by payment of all or a portion of proceeds to the non-profit entity associated with the user whose participation is requested.

Although the invention has been described and pictured in an exemplary form with a certain degree of particularity, it should be understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. An economic allotment computing system, comprising:
a first engine programmed to receive, from a plurality of users, user profile information, and to receive an association by each of the plurality of users of a non-profit endeavor with the respective profile information;
a second engine programmed to sell to marketers the user profile information of ones of the plurality of users for at least one of targeted marketing, promotions, polling, and surveying;
a third engine programmed to allot at least a portion of proceeds obtained from the sale executed by said second engine to the non-profit associated with the one of the plurality of users undertaking an action indicated by at least one of the targeted marketing, promotions, polling and surveying.
